(19) United States
(12) Patent Application Publication
(10) Pub. No.: US 2004/0149684 A1
(43) Pub. Date: Aug. 5, 2004

(54) Method for manufacturing optical compensation film and device thereof

(75) Inventor: Robert Wu, Pingjen City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Optimax Technology Corporation, Pingjen City (TW)

(21) Appl. No.: 10/695,215

(22) Filed: Oct. 28, 2003

(30) Foreign Application Priority Data
Oct. 28, 2002 (TW) 091132027

(51) Int. Cl. B05D 5/06

(52) U.S. Cl. 216/24; 427/162; 427/558

(57) ABSTRACT

A method for manufacturing an optical compensation film and the device thereof are provided. The method includes steps as follows. First, a horizontal condensing electric field orientation layer along an x-axis is formed by exposing a first linear photo reactive polymer layer on a first substrate under a transmissive polarized-light UV. Secondly, a first optical anisotropy film having the x-axis optic axis is formed on the horizontal condensing electric field orientation layer. Thirdly, a vertical condensing electric field orientation layer along a y-axis is formed on the first optical anisotropy film by exposing a second linear photo reactive polymer layer under a reflective polarized-light UV. Fourthly, a second optical anisotropy film having the y-axis optic axis is formed on the vertical condensing electric field orientation layer. Thereby, an optical compensation film with double optical-axes is formed.

### FIELD OF THE INVENTION

This invention relates to a method for manufacturing an optical compensation film, and especially to one method for manufacturing an optical compensation film with double optical-axes on a liquid crystal display for displaying a wide view.

### BACKGROUND OF THE INVENTION

Since the liquid crystal display has the features of small volume and low power consumption, it has become a popular display used for notebooks and personal computers. In general, the liquid crystal display has an optical compensation film mounted therein, in which the optical compensation film is used for compensating the visible view angle of the light emitted from the liquid crystal. The optical compensation film is usually manufactured by being exposed under the UV light both horizontally and vertically so that the film would have both horizontal and vertical orientations. Please refer to FIGS. 1(a)˜(b). FIGS. 1(a)˜(b) show the film positioned along the x-axis (horizontal) and along the y-axis (vertically) under the UV light exposure according to the prior art. In the traditional method for manufacturing a compensation film, the film with orientation 11 along the x-axis is formed by exposing the film 10 disposed along the x-axis under a UV light exposure with an electric field along the x-axis. Next, since the film is not continuously rolled-up and allowed to be turned, in order to form a film with an orientation 11 along the x-axis and a orientation 13 along the y-axis under the same exposing conditions, the film 10 positioned along the x-axis must be turned vertically before exposed. Therefore, the optical compensation film has orientations disposed along the x-axis and y-axis is obtained. During the manufacturing method as mentioned above, the film always needs to be cut into pieces for being turned easily. However, since the original film is a continuously rolled-up film, the film needs to be cut into pieces and placed at the precise position for being exposed, which are both time-consuming procedures. Hence, it's hard to effectively improve the producing speed of the production line. In addition, the film 10 disposed along the x-axis and the film 12 disposed along the y-axis can't be exposed simultaneously, therefore the exposing time can't be reduced either. Thus, the traditional manufacturing procedure is a relatively high cost procedure.

As to another method for manufacturing a compensation film, the film is drawn along two directions in sequences so that the compensation film would have both parallel and perpendicular orientations. Nevertheless, the method will easily cause the stress damages when pulling or drawing film. Besides, the heat stability of the film made in this way is low, even the deformation and the shrinking will occur if the temperature is too high.

According to the technical defects described above, it is known that the discontinuous producing method for compensation film not only has a long manufacturing time but also highly costs. Therefore, how to design a continuous production line and how to shorten the time for placing the film at the precise exposure position have become major problems waited to be solved in the industry. The applicant keeps on carving unflaggingly to develop “method for manufacturing optical compensation film and device thereof” through wholehearted experience and research. Therefore, the invention provides the method for manufacturing an optical compensation film and the device thereof. The method for manufacturing the optical compensation film on a liquid crystal display to display a wide view includes steps of providing a first rolled-up film, and coating linear photo reactive polymer layers etc. According to the method and device of the present invention, it's possible to increase the utility of the UV light and to have a selection of using an optical compensation film with double optical-axes.

### SUMMARY OF THE INVENTION

It is an object of the present invention to provide an exposing method for manufacturing an optical compensation film attached on one of a thin film transistor (TFT) and a color filter (CF) for a liquid crystal display to display a wide view.

It is another object of the present invention to provide a method with less cost and better utility of a UV light for manufacturing an optical compensation film with double optical axes.

It is another object of the present invention to form a vertical condensing electric field orientation layer along the y-axis through exposing a photo sensitive layer under a reflective polarized-light UV produced by a polarized-light generator.

It is another object of the present invention to provide a chance of forming an optical compensation film with double optical axes by exposing a first photo sensitive layer and a second photo sensitive layer under a reflective polarized-light UV and a transmissive polarized-light UV simultaneously.

According to another aspect of the present invention, a method for manufacturing an optical compensation film includes steps as follows. Firstly, a first substrate is provided and a first linear photo reactive polymer layer is formed on the first substrate. Secondly, the first linear photo reactive polymer layer is exposed in a transmissive polarized-light UV for forming a horizontal condensing electric field orientation layer along the x-axis. Thirdly, a first liquid crystal polymer layer is formed on the horizontal condensing electric field orientation layer and is heated. Fourthly, the first liquid crystal polymer layer is exposed in a first UV light for forming a first optical anisotropy film having the x-axis optic axis. Fifthly, a second linear photo reactive polymer layer is formed on the first optical anisotropy film and is exposed in a reflective polarized-light UV for forming a vertical condensing electric field orientation layer along the y-axis. Sixthly, a second liquid crystal polymer layer is formed on the vertical condensing electric field orientation layer and is heated. Seventhly, the second liquid crystal polymer layer is exposed in a second UV light for forming a second optical anisotropy film having the y-axis optic axis. Thereby, an optical compensation film with double optical-axes is formed with the first optical anisotropy film and the second optical anisotropy film.

Preferably, the first linear photo reactive polymer layer is formed by coating a linear photo reactive polymer on the first substrate.

Preferably, the second linear photo reactive polymer layer is formed by coating the linear photo reactive polymer on the first optical anisotropy film.

Preferably, the optical compensation film with double optical-axes has an in-plane retardation value Rₒ, where 0≦Rₒ≦400 nm, and an out-of-plane retardation value Rₜₕ, where 0≦Rₜₕ≦300 nm.

Preferably, the optical compensation film is attached on one of a thin film transistor and a color filter for a liquid crystal display to display a wide view.

Preferably, the first substrate is formed by a first rolled-up film.

Preferably, the x-axis is parallel to one moving direction of the first rolled-up film and is perpendicular to the y-axis.

Preferably, the transmissive polarized-light UV, the reflective polarized-light UV the first UV light, and the second UV light are provided by a UV light source.

Preferably, the UV light source condenses a third UV light as a parallel beam by a condenser.

Preferably, the parallel beam is an electromagnetic wave along a z-axis and has a horizontal electric field component along the x-axis and a vertical electric field component along the y-axis, both vibrating on an x-y plane.

Preferably, the method further includes to provide a first reflector and a second reflector for improving the utility of the third UV light by means of reflecting the vertical electric field component to polarize the second linear photo reactive polymer layer.

Preferably, the UV light source generates the reflective polarized-light UV and the transmissive polarized-light UV via a polarized-light generator by receiving the parallel beam and reflecting the vertical electric field component and transmitting the horizontal electric field component simultaneously.

Preferably, the polarized-light generator includes plural layers of quartz chips, and is positioned between the condenser and the first rolled-up film.

Preferably, the plural layers of quartz chips have an inclination between 30 to 60 degrees for reflecting the second electric field component.

Preferably, the inclination is 57 degrees of Brewster Angle for transmitting the horizontal electric field component.

In accordance with another aspect of the present invention, an exposing procedure for manufacturing an optical compensation film on a liquid crystal display for displaying a wide view is provided. The procedure includes steps as follows. Firstly, a first linear photo reactive polymer layer is formed on a first substrate and is exposed in a transmissive polarized-light UV for forming a horizontal condensing electric field orientation layer along the x-axis. Secondly, a first liquid crystal polymer layer is formed on the horizontal condensing electric field orientation layer and is heated. Thirdly, the first liquid crystal polymer layer is exposed in a first UV light for forming a first optical anisotropy film having the x-axis optic axis. Fourthly, a second linear photo reactive polymer layer is formed on the first optical anisotropy film and is exposed in a reflective polarized-light UV for forming a vertical condensing electric field orientation layer along the y-axis. Fifthly, a second liquid crystal polymer layer is formed on the vertical condensing electric field orientation layer and is heated. Finally, the second liquid crystal polymer layer is exposed in a second UV light for forming a second optical anisotropy film having the y-axis optic axis. Thereby, an optical compensation film with double optical-axes is formed with the first optical anisotropy film and the second optical anisotropy film.

Preferably, the first substrate is formed by a first rolled-up film.

In accordance with another aspect of the present invention, an exposing device for manufacturing an optical compensation film is provided. The device includes a driving device for driving a first rolled-up film to form a substrate of the optical compensation film, a first coater, a UV light source, a condenser, a polarized-light generator and a second coater. The first coater coats a first linear photo reactive polymer on the substrate to form a first linear photo reactive polymer layer. The UV light source emits a first UV light, a second UV light and a third UV light. The condenser condenses the first UV light as a parallel beam. The polarized-light generator has plural layers of quartz chips, positioned between the condenser and the first rolled-up film, forms a reflective polarized-light UV and a transmissive polarized-light UV by receiving the parallel beam, and forms a horizontal condensing electric field orientation layer along the x-axis by polarizing the first linear photo reactive polymer layer with the transmissive polarized-light UV. The second coater forms a first optical anisotropy film having the x-axis optic axis by steps of coating a first liquid crystal polymer layer on the first linear photo reactive polymer layer, heating and exposing with the second UV light.

Preferably, the parallel beam is an electromagnetic wave along the z-axis and has a horizontal electric field component along the x-axis and a vertical electric field component along the y-axis, both vibrating on the x-y plane.

Preferably, the device further includes a second linear photo reactive polymer layer formed on the first optical anisotropy film by coating the linear photo reactive polymer, a vertical condensing electric field orientation layer along the y-axis on the second linear photo reactive polymer layer by exposing with the reflective polarized-light UV and a second optical anisotropy film having the y-axis optic axis on the second linear photo reactive polymer layer by steps of coating the second linear photo reactive polymer layer, heating and exposing with the third UV light.

Preferably, the x-axis is parallel to one moving direction of the first rolled-up film and is perpendicular to the y-axis.

In accordance with the other aspect of the present invention, an exposing procedure for manufacturing a first optical compensation film and a second optical compensation film is provided. The procedure includes steps as follows. Firstly, a first rolled-up film with a first optical anisotropy film along the y-axis and a second rolled-up film with a second optical anisotropy film along the x-axis are both provided. Secondly, a first linear photo reactive polymer layer and a second linear photo reactive polymer layer are formed on the first rolled-up film and the second rolled-up film respectively. Thirdly, a UV light source is provided to emit a first UV light, a second UV light, and a third UV light. Fourthly, the first UV light is condensed as a parallel beam by a condenser. Fifthly, a reflective polarized-light UV and a transmissive polarized-light UV are generated by receiving the parallel beam, reflecting a vertical electric field component and transmitting a horizontal electric field component simultaneously. Sixthly, the first linear photo reactive polymer layer and the second linear photo reactive polymer layer are respectively exposed with the transmissive polarized-light UV and the reflective polarized-light UV for forming a horizontal condensing electric field orientation layer along the x-axis and a vertical condensing electric field orientation layer along the y-axis. Seventhly, a first liquid crystal polymer layer is coated on the horizontal condensing electric field orientation layer and a second liquid crystal polymer layer is coated on the vertical condensing electric field orientation layer respectively. Eighthly, the horizontal condensing electric field orientation layer and the vertical condensing electric field orientation layer are heated. Finally, the horizontal condensing electric field orientation layer and the vertical condensing electric field orientation layer are respectively exposed with the second UV light and the third UV light for forming a third optical anisotropy film having the x-axis optic axis and a fourth optical anisotropy film having the y-axis optic axis.

Preferably, the first linear photo reactive polymer layer and the second linear photo reactive polymer layer are formed by coating a linear photo reactive polymer on the first rolled-up film and the second rolled-up film respectively.

Preferably, the parallel beam is an electromagnetic wave along a z-axis and has the horizontal electric field component along the x-axis and the vertical electric field component along the y-axis, both vibrating on the x-y plane.

Preferably, the reflective polarized-light UV and the transmissive polarized-light UV are both generated by a polarized-light generator.

Preferably, the x-axis is parallel to the moving directions of the first rolled-up film and the second rolled-up film and is perpendicular to the y-axis.

In accordance with the other aspect of the present invention, a method for manufacturing an optical compensation film is provided. The method includes steps as follows. Step a), a reflective polarized-light UV and a transmissive polarized-light UV are generated. Step b), a first linear photo reactive polymer layer is exposed in the transmissive polarized-light UV for forming a horizontal electric field orientation layer. Step c), a first liquid crystal polymer layer is coated on the horizontal electric field orientation layer for forming a first optical anisotropy film along the x-axis. Step d), a second linear photo reactive polymer layer on the first optical anisotropy film is exposed in the reflective polarized-light UV for forming a vertical electric field orientation layer. Step e), a second liquid crystal polymer layer is coated on the vertical electric field orientation layer for forming a second optical anisotropy film along the y-axis.

Preferably, the reflective polarized-light UV and the transmissive polarized-light UV are generated by polarizing a parallel beam being an electromagnetic wave along a z-axis and having an electric field with multiple vibrating directions.

Preferably, the parallel beam is a first UV light with a wave length of 190 nm to 400 nm.

Preferably, the first linear photo reactive polymer layer is formed by coating a first linear photo reactive polymer on a substrate.

Preferably, the step a) is achieved by a polarized-light generator.

Preferably, the reflective polarized-light UV and the transmissive polarized-light UV are respectively formed by reflecting and transmitting a vertical component and a horizontal component of the electric field with multiple vibrating directions.

Preferably, the horizontal electric field orientation layer and the vertical electric field orientation layer are a horizontal condensing electric field orientation layer along the x-axis and a vertical condensing electric field orientation layer along the y-axis respectively.

Preferably, the step c) and step e) both further include steps of heating and exposing with a second UV light and a third UV light respectively.

In accordance with another aspect of the present invention, a method for manufacturing an optical compensating film is provided. The method includes steps as fallows. Step a), a reflective polarized-light UV and a transmissive polarized-light UV are generated by receiving a parallel beam. Step b), a first linear photo reactive polymer layer and a second linear photo reactive polymer layer are respectively polarized with the transmissive polarized-light UV and the reflective polarized-light UV for forming a horizontal electric field orientation layer and a vertical electric field orientation layer respectively. Step c), a first liquid crystal polymer layer is coated on the first linear photo reactive polymer layer and a second liquid crystal polymer layer is coated on the second linear photo reactive polymer layer for forming a first optical anisotropy liquid crystal polymer film along the x-axis and a second optical anisotropy liquid crystal polymer film along the y-axis respectively.

Preferably, the parallel beam is an electromagnetic wave along a z-axis having an electric field with multiple vibrating directions

In accordance with another aspect of the present invention, a method for manufacturing an optical compensating film is provided. The method includes steps as follows. Step a), a reflective polarized-light UV and a transmissive polarized-light UV are generated by receiving a parallel beam. Step b), a first linear photo reactive polymer layer and a second linear photo reactive polymer layer are polarized with the transmissive polarized-light UV and the reflective polarized-light UV for forming a horizontal electric field orientation layer and a vertical electric field orientation layer respectively. Step c), a first liquid crystal polymer layer is coated on the first linear photo reactive polymer layer and a second liquid crystal polymer layer is coated on the second linear photo reactive polymer layer for forming a first optical anisotropy liquid crystal polymer film along the x-axis and a second optical anisotropy liquid crystal polymer film along the y-axis respectively.

Preferably, the parallel beam is an electromagnetic wave along a specific direction having an electric field with multiple vibrating directions.

Preferably, the specific direction is perpendicular to the x-axis and the y-axis.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1(a) is a schematic diagram illustrating the film positioned along the x-axis (horizontally) under a UV light exposure according to the prior art;

FIG. 1(b) is a schematic diagram illustrating the film positioned along the y-axis (vertically) under a UV light exposure according to the prior art;

FIG. 2 is a schematic diagram illustrating the method for manufacturing an optical compensation film according to a preferred embodiment of the present invention;

FIG. 3 shows the substrate in FIG. 2 according to a preferred embodiment of the present invention;

FIG. 4 is a schematic diagram illustrating the substrate in FIG. 3 is coated with a first linear photo reactive polymer layer according to a preferred embodiment of the present invention;

FIG. 5 is a schematic diagram illustrating the first linear photo reactive polymer layer in FIG. 4 exposed under a transmissive polarized-light UV according to a preferred embodiment of the present invention;

FIG. 6 is a schematic diagram illustrating the horizontal condensing electric field orientation layer along the x-axis in FIG. 5 coated with a first liquid crystal polymer layer according to a preferred embodiment of the present invention;

FIG. 7 is a schematic diagram illustrating the first optical anisotropy film formed by exposing the first liquid crystal polymer layer in FIG. 6 under a UV light according to a preferred embodiment of the present invention;

FIG. 8 is a schematic diagram illustrating the second linear photo reactive polymer layer coated on the first optical anisotropy film in FIG. 7 according to a preferred embodiment of the present invention;

FIG. 9 is a schematic diagram illustrating the second linear photo reactive polymer layer in FIG. 8 exposed under a reflective polarized-light UV according to a preferred embodiment of the present invention;

FIG. 10 is a schematic diagram illustrating the vertical condensing electric field orientation layer along the y-axis in FIG. 9 coated with a second liquid crystal polymer layer according to a preferred embodiment of the present invention;

FIG. 11 is a schematic diagram illustrating the second optical anisotropy film formed by exposing the second liquid crystal polymer layer in FIG. 10 under the UV light according to a preferred embodiment of the present invention;

FIG. 12 shows a notebook with the optical compensation films according to a preferred embodiment of the present invention;

FIG. 13 is a schematic diagram illustrating the method for manufacturing an optical compensation film according to another preferred embodiment of the present invention; and

FIG. 14 is a schematic diagram illustrating the first optical compensation film and the second optical compensation film formed by the method in FIG. 13.

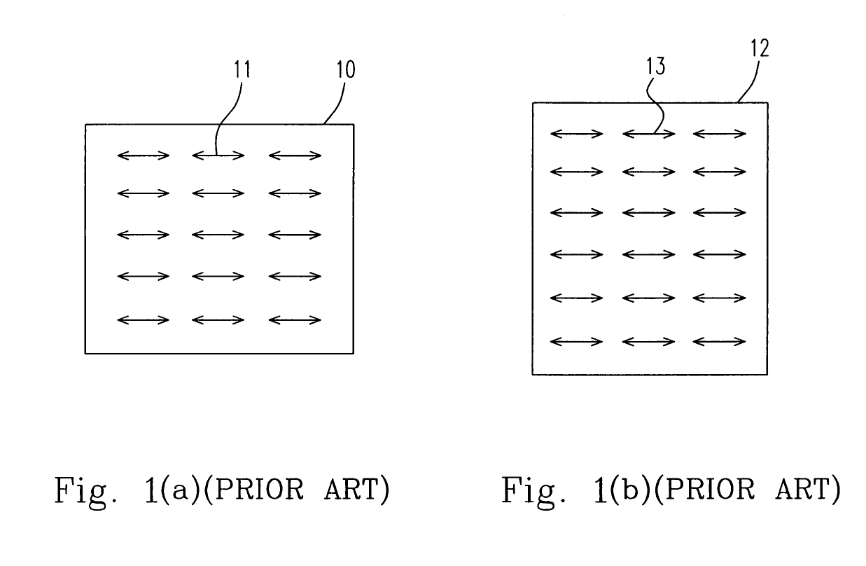

### DETAILED DESCRIPTION OF THE PREFERRED EMBODIMENT

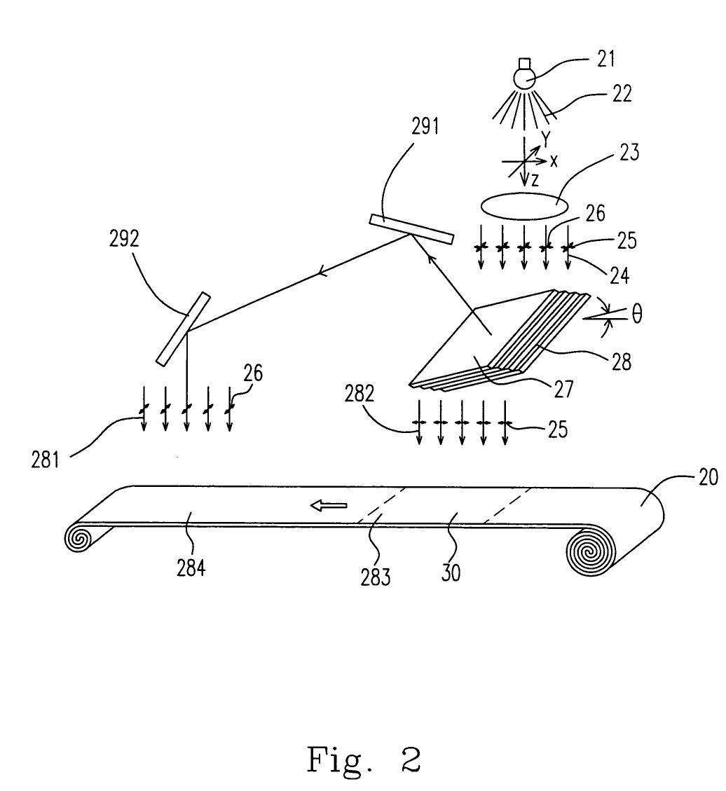

The present invention will now be described more specifically with reference to the following embodiments. The method for manufacturing an optical compensation film, which is installed in a liquid crystal display for displaying a wide view, is disclosed as follows. Please refer to FIGS. 2 to 12. FIG. 2 is a schematic diagram illustrating the method for manufacturing an optical compensation film, which is installed in a liquid crystal display, for displaying a wide view.

The method includes steps as following. As shown in FIG. 2, the first rolled-up film 20 is provided for forming the first substrate 30 of the optical compensation film. The UV light source 21 emits the UV light 22, and the condenser 23 converges the UV light 22 into a parallel beam 24, which is an electromagnetic wave along the z-axis. The parallel beam 24 has a horizontal electric field component 25 along the x-axis and a vertical electric field component 26 along the y-axis, which both vibrate on the x-y plane. The polarized-light generator 27 includes plural layers of quartz chips 28 and is disposed between the condenser 23 and the first rolled-up film 20. The generator 27 reflects and transmits the vertical electric field component 26 and the horizontal electric field component 25 of the parallel beam 24 simultaneously for generating a reflective polarized-light UV 281 and a transmissive polarized-light UV 282 respectively. The first position 283 and the second position 284 of the first rolled-up film 20 are exposed under the transmissive polarized-light UV 282 and the reflective polarized-light UV 281 respectively. The reflective polarized-light UV 281 arrives the second position 284 by being reflected by the first reflective mirror 291 and the second reflective mirror 292. Therefore, the first position 283 and the second position 284 can be exposed under UV simultaneously. Besides, the first substrate 30 will move from the first position 283 to the second position 284 after certain procedures is accomplished at the first position 283. Then, the following procedures are performed at the second position 284. In such a way, the rolled-up film needs not to be cut into pieces and the manufacturing process is continuous.

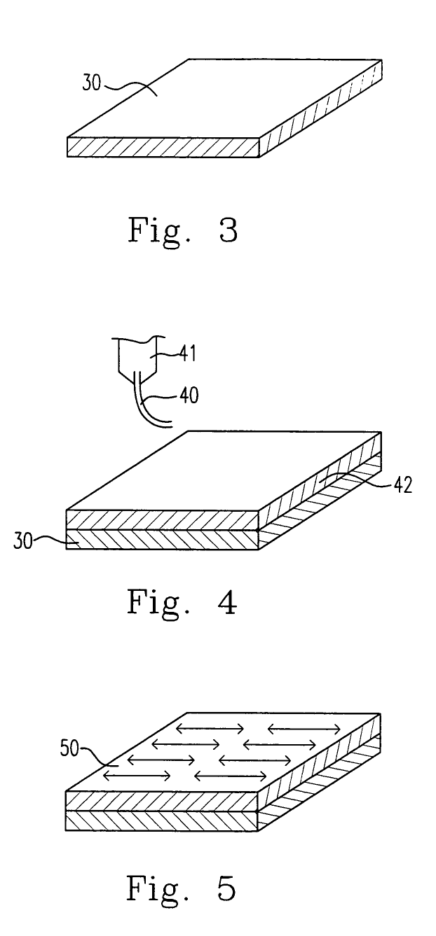

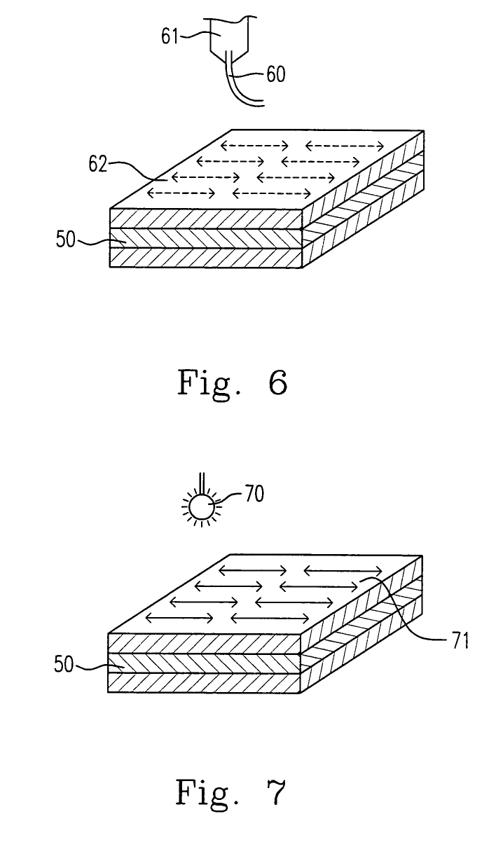

Please refer to FIGS. 3 to 4. FIG. 3 shows the substrate 30 in FIG. 2. FIG. 4 shows that the linear photo reactive polymer 40 is coated on the first substrate 30 by a coater 41 for forming a first linear photo reactive polymer layer 42. Please refer to FIGS. 2, 4 and 5. FIG. 5 is a schematic diagram illustrating the first linear photo reactive polymer layer in FIG. 4 exposed under a transmissive polarized-light U. The linear photo reactive polymer layer 42 is polarized by being exposed under the transmissive polarized-light UV 282 for forming a horizontal condensing electric field orientation layer 50 along the x-axis. Please refer to FIG. 6. FIG. 6 is a schematic diagram illustrating the horizontal condensing electric field orientation layer along the x-axis in FIG. 5 coated with a first liquid crystal polymer layer. The first liquid crystal polymer layer 62 is formed on the horizontal condensing electric field orientation layer 50 by coating the linear liquid crystal polymer 60 thereon with the coater 61. Then, the first liquid crystal polymer layer 62 is heated. Please refer to FIG. 7. FIG. 7 is a schematic diagram illustrating the first optical anisotropy film formed by exposing the first liquid crystal polymer layer in FIG. 6 under a general UV light. The first liquid crystal polymer layer 62 is exposed under the general UV light 70 for forming the first optical anisotropy film 71 with the x-axis optic axis.

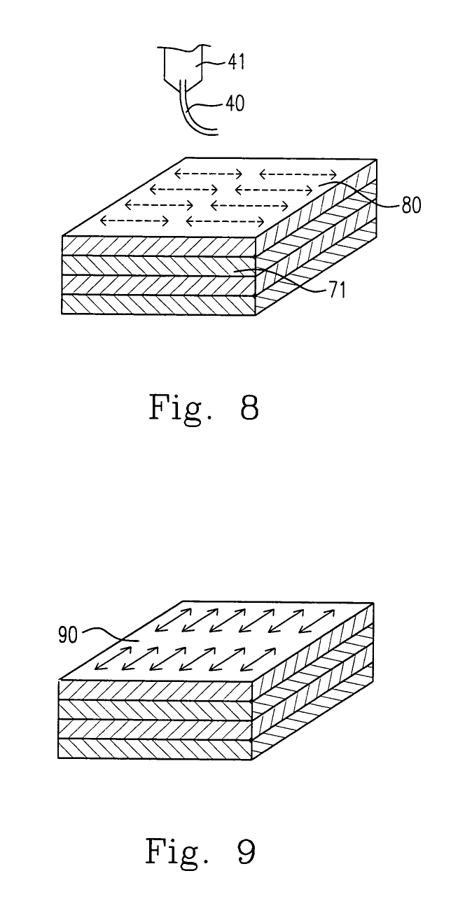

Please refer to FIGS. 8 to 9. FIG. 8 is a schematic diagram illustrating the second linear photo reactive polymer layer coated on the first optical anisotropy film in FIG. 7. FIG. 9 is a schematic diagram illustrating the second linear photo reactive polymer layer in FIG. 8 exposed under a reflective polarized-light UV. The second linear photo reactive polymer layer 80 is formed on the first optical anisotropy film 71 by coating the linear photo reactive polymer 40 thereon via the coater 41. The second linear photo reactive polymer layer 80 is polarized by being exposed under the reflective polarized-light UV 281 (FIG. 2) for forming a vertical condensing electric field orientation layer 90 along the y-axis.

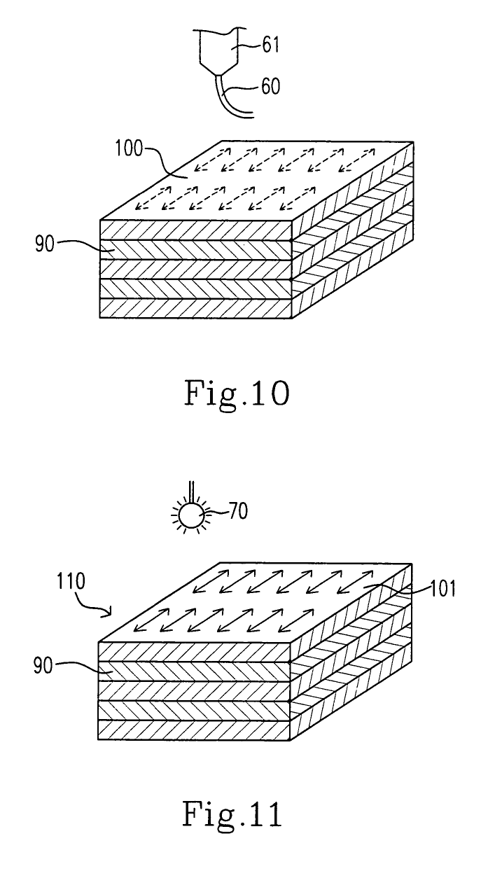

Please refer to FIG. 10. FIG. 10 is a schematic diagram illustrating the vertical condensing electric field orientation layer along the y-axis in FIG. 9 coated with a second liquid crystal polymer layer. The second liquid crystal polymer layer 100 is formed on the vertical condensing electric field orientation layer 90 by coating the liquid crystal polymer 60 thereon with the coater 61. Then, the second liquid crystal polymer layer 100 is heated. Please refer to FIG. 11. FIG. 11 is a schematic diagram illustrating the second optical anisotropy film formed by exposing the second liquid crystal polymer layer in FIG. 10 under the UV light. The second liquid crystal polymer layer 100 is exposed under the general UV light 70 for forming the second optical anisotropy film 101 with the y-axis optic axis. Thereby, the optical compensation film 110 with double optical-axes is formed with the first optical anisotropy film 71 and the second optical anisotropy film 101.

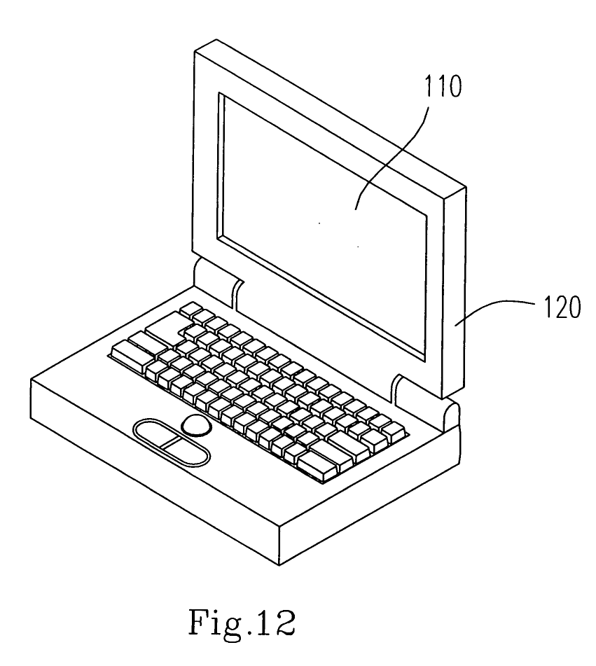

Please refer to FIG. 12. FIG. 12 is a schematic diagram illustrating the optical compensation film used on a notebook for displaying a wide view. The notebook 120 has the optical compensation film 110.

In addition, please re-refer to above FIGS. 2, 11, and 12, it's practical to provide the reflector 291 and/or the reflector 292 for improving the utility efficiency of the UV light 24. Further, the plural layers of quartz chips 28 have an inclination θ between 30 to 60 degrees for reflecting the second electric field component. While the inclination θ is at 57 degrees of Brewster Angle, it is the optimum state for transmitting, the horizontal electric field component 25. The optical compensation film 110 has an in-plane retardation value Rₒ, where 0≦Rₒ≦400 nm, and an out-of-plane retardation value Rₜₕ where 0≦Rₜₕ≦300 nm respectively. Driving devices (not shown) can be provided for driving the first rolled-up film 20 for forming the first substrate 30 during the procedure of manufacturing the optical compensation film 110.

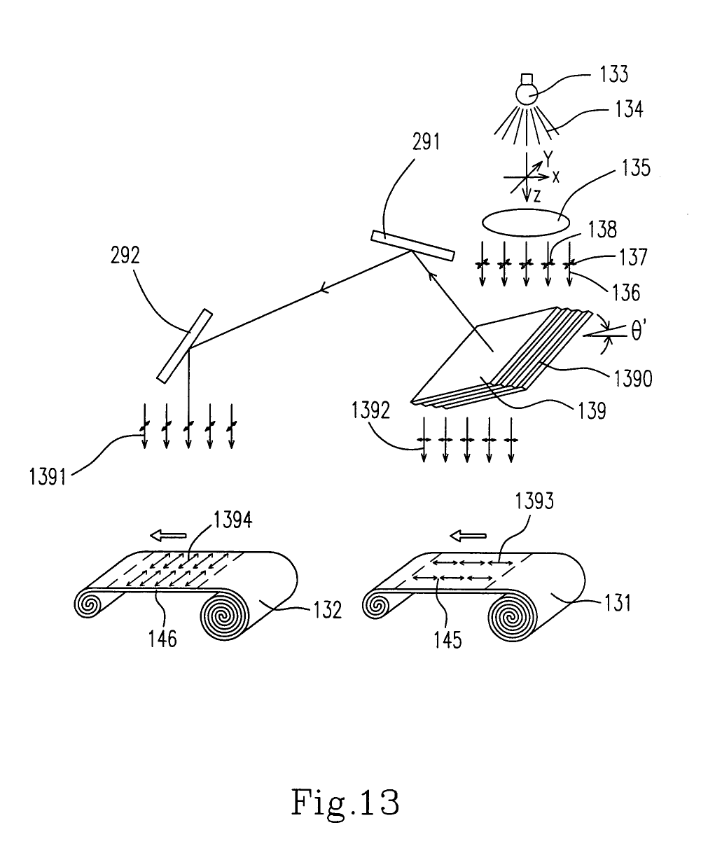

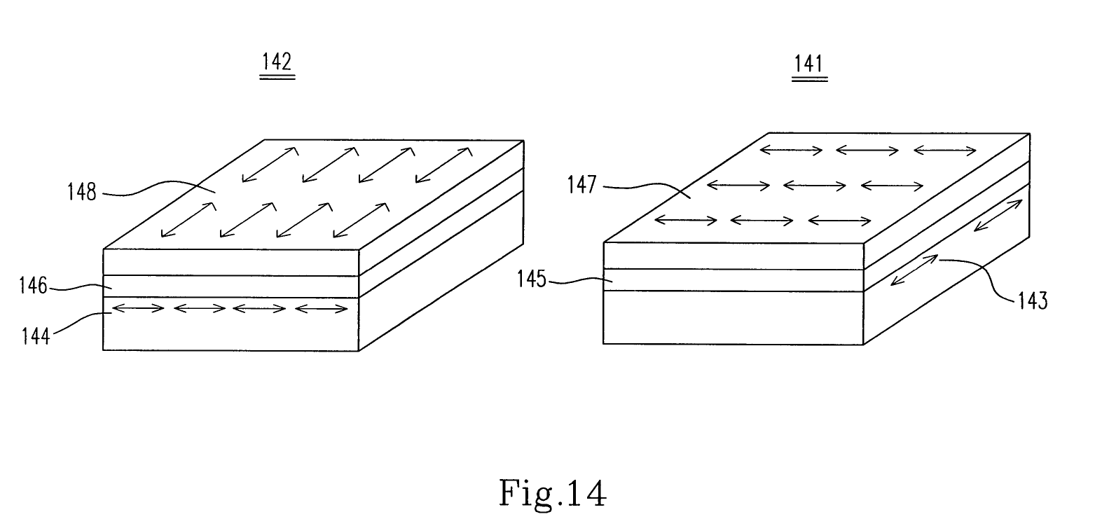

Please refer to FIGS. 13 to 14. FIG. 13 is a schematic diagram illustrating the method for manufacturing an optical compensation film according to another preferred embodiment of the present invention. The polarized-light generator 139 includes plural layers of quartz chips 1390 and is disposed between the condenser 135 and the semi-finished rolled-up film 131. The condenser 135 forms the parallel beam 136 after receiving the UV light 134. The generator 139 reflects and transmits the vertical electric field component 138 along the y-axis and the horizontal electric field component 137 along the x-axis of the parallel beam 136 simultaneously for generating the reflective polarized-light UV 1391 and the transmissive polarized UV 1392 respectively. The semi-finished rolled-up film 131 having the optical anisotropy of the y-axis is exposed under the transmissive polarized-light UV 1392. The semi-finished rolled-up film 132 having the optical anisotropy of the x-axis is exposed under the reflective polarized-light UV 1391.

The first linear photo reactive polymer layer 145 is polarized by being exposed under the transmissive polarized-light UV 1392 for forming the third horizontal condensing electric field orientation layer 1393 along the x-axis. FIG. 14 is a schematic diagram illustrating the first optical compensation film and the second optical compensation film formed by another method of the present invention. Please refer to FIGS. 13 to 14. The first liquid crystal polymer layer 147 is formed on the third horizontal condensing electric field orientation layer 1393 by being coated with the linear liquid crystal polymer. Then, the first liquid crystal polymer layer 147 is heated and exposed under a UV light for forming the optical compensation film 141. Simultaneously, the second linear photo reactive polymer layer 146 is polarized by being exposed under the reflective polarized-light UV 1391 for forming the fourth vertical condensing electric field orientation layer 1394 along the y-axis. The second liquid crystal polymer layer 148 is formed on the fourth vertical condensing electric field orientation layer 1394 by being coated with the liquid crystal polymer. Then, the second liquid crystal polymer layer 148 is heated and exposed under the general UV light for forming the optical compensation film 142.

In addition, please refer to FIG. 13, it's practical to provide the reflector 291 and/or the reflector 292 for improving the utility efficiency of the UV light 136. Further, the plural layers of quartz chips 1390 have an inclination θ′ between 30 to 60 degrees for reflecting the second electric field component. While the inclination θ′ is at 57 degrees of Brewster Angle, it is the optimum state for transmitting, the horizontal electric field component 137. The optical compensation films 141, and 142 have an in-plane retardation value Rₒ, where 0≦Rₒ≦400 nm, and an out-of-plane retardation value Rₜₕ, where 0≦Rₜₕ≦300 nm respectively. Driving devices (not shown) can be provided for driving the semi-finished rolled-up films 131 and 132 respectively during the procedure of manufacturing the optical compensation films 141 and 142.

The equation used in the present invention is:

Rₜₕ={[(nₓ+n_{y})/2]−n_{z}}×d

Rₒ=(nₓ−n_{y})×d

Wherein the Rₜₕ is the out-of-plane retardation value;

The Rₒ is the in-plane retardation value;

The nₓ is the reflective index along the x-axis of the optical compensation film;

The n_{y} is the reflective index along the y-axis of the optical compensation film;

The n_{z} is the reflective index along the z-axis of the optical compensation film;

The d is the thickness of the liquid crystal polymer layer of the optical compensation film;

While the nₓ=n_{y}>n_{z}, the film is a C-Film,

While the nₓ>n_{y}>n_{z}, the film is a Biaxial-Film;

While the nₓ>n_{y}=n_{z}, the film is an A-Film;

All three above-mentioned films are different from the film for displaying a wide view of the present invention.

As given above, the present invention is to provide a method and device thereof for manufacturing an optical compensation film with double optical-axes by being exposed under a transmissive polarized-light UV and a reflective polarized-light UV. Besides, the method provided in the present invention can effectively improve the utility efficiency of the polarized-light UV to reduce the cost, and also effectively increase the producing speed of the production line. Not only the drawbacks of the prior arts are effectively improved, but also the invention is worthy for the industries.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A method for manufacturing an optical compensation film, comprising steps of:
a) providing a first substrate;
b) forming a first linear photo reactive polymer layer on said first substrate;
c) exposing said first linear photo reactive polymer layer in a transmissive polarized-light UV for forming a horizontal condensing electric field orientation layer along an x-axis;
d) forming a first liquid crystal polymer layer on said horizontal condensing electric field orientation layer;
e) heating said first liquid crystal polymer layer;
f) exposing said first liquid crystal polymer layer in a first UV light for forming a first optical anisotropy film having said x-axis optic axis;
g) forming a second linear photo reactive polymer layer on said first optical anisotropy film;
h) exposing said second linear photo reactive polymer layer in a reflective polarized-light UV for forming a vertical condensing electric field orientation layer along a y-axis;
i) forming a second liquid crystal polymer layer on said vertical condensing electric field orientation layer;
j) heating said second liquid crystal polymer layer; and
k) exposing said second liquid crystal polymer layer in a second UV light for forming a second optical anisotropy film having said y-axis optic axis, thereby an optical compensation film with double optical-axes being formed with said first optical anisotropy film and said second optical anisotropy film.

2. The method as claimed in claim 1, wherein said first linear photo reactive polymer layer is formed by coating a linear photo reactive polymer on said first substrate.

3. The method as claimed in claim 1, wherein said second linear photo reactive polymer layer is formed by coating said linear photo reactive polymer on said first optical anisotropy film.

4. The method as claimed in claim 1, wherein said optical compensation film with double optical-axes has an in-plane retardation value Rₒ, where 0≦Rₒ≦400 nm, and an out-of-plane retardation value Rₜₕ, where 0≦Rₜₕ≦300 nm.

5. The method as claimed in claim 1, wherein said optical compensation film is attached on one of a thin film transistor and a color filter for a liquid crystal display to display a wide view.

6. The method as claimed in claim 1, wherein said first substrate is formed by a first rolled-up film.

7. The method as claimed in claim 6, wherein said x-axis is parallel to one moving direction of said first rolled-up film and is perpendicular to said y-axis.

8. The method as claimed in claim 1, wherein said transmissive polarized-light UV, said reflective polarized-light UV, said first UV light, and said second UV light are provided by a UV light source.

9. The method as claimed in claim 8, wherein said UV light source condenses a third UV light as a parallel beam by a condenser.

10. The method as claimed in claim 9, wherein said parallel beam is an electromagnetic wave along a z-axis and has a horizontal electric field component along said x-axis and a vertical electric field component along said y-axis, both vibrating on an x-y plane.

11. The method as claimed in claim 9 further comprising to provide a first reflector and a second reflector for improving the utility of said third UV light by means of reflecting said vertical electric field component to polarize said second linear photo reactive polymer layer.

12. The method as claimed in claim 11, wherein said UV light source generates said reflective polarized-light UV and said transmissive polarized-light UV via a polarized-light generator by receiving said parallel beam and reflecting said vertical electric field component and transmitting said horizontal electric field component simultaneously.

13. The method as claimed in claim 12, wherein said polarized-light generator includes plural layers of quartz chips, and is positioned between said condenser and said first rolled-up film.

14. The method as claimed in claim 13, wherein said plural layers of quartz chips have an inclination between 30 to 60 degrees for reflecting said second electric field component.

15. The method as claimed in claim 14, wherein said inclination is 57 degrees of Brewster Angle for transmitting said horizontal electric field component.

16. An exposing procedure for manufacturing an optical compensation film on a liquid crystal display for displaying a wide view, comprising steps of:
a) forming a first linear photo reactive polymer layer on a first substrate;
b) exposing said first linear photo reactive polymer layer in a transmissive polarized-light UV for forming a horizontal condensing electric field orientation layer along an x-axis;
c) forming a first liquid crystal polymer layer on said horizontal condensing electric field orientation layer;
d) heating said first liquid crystal polymer layer;
e) exposing said first liquid crystal polymer layer in a first UV light for forming a first optical anisotropy film having an x-axis optic axis;
f) forming a second linear photo reactive polymer layer on said first optical anisotropy film;
g) exposing said second linear photo reactive polymer layer in a reflective polarized-light UV for forming a vertical condensing electric field orientation layer along a y-axis;
h) forming a second liquid crystal polymer layer on said vertical condensing electric field orientation layer;
i) heating said second liquid crystal polymer layer; and
j) exposing said second liquid crystal polymer layer in a second UV light for forming a second optical anisotropy film having said y-axis optic axis, thereby an optical compensation film with double optical-axes being formed with said first optical anisotropy film and said second optical anisotropy film.

17. The procedure as claimed in claim 16, wherein said first substrate is formed by a first rolled-up film.

18. An exposing device for manufacturing an optical compensation film, comprising:
a driving device for driving a first rolled-up film to form a substrate of said optical compensation film;
a first coater for coating a first linear photo reactive polymer on said substrate to form a first linear photo reactive polymer layer;
a UV light source for emitting a first UV light, a second UV light and a third UV light;
a condenser for condensing said first UV light as a parallel beam;
a polarized-light generator having plural layers of quartz chips, and positioned between said condenser and said first rolled-up film, forming a reflective polarized-light UV and a transmissive polarized-light UV by receiving said parallel beam, and forming a horizontal condensing electric field orientation layer along an x-axis by polarizing said first linear photo reactive polymer layer with said transmissive polarized-light UV; and
a second coater for forming a first optical anisotropy film having said x-axis optic axis by steps of coating a first liquid crystal polymer layer on said first linear photo reactive polymer layer, heating and exposing with said second UV light.

19. The device as claimed in claim 18, wherein said parallel beam is an electromagnetic wave along a z-axis and has a horizontal electric field component along said x-axis and a vertical electric field component along a y-axis, both vibrating on an x-y plane.

20. The device as claimed in claim 19 further comprising:
a second linear photo reactive polymer layer formed on said first optical anisotropy film by coating said linear photo reactive polymer;
a vertical condensing electric field orientation layer along said y-axis on said second linear photo reactive polymer layer by exposing with said reflective polarized-light UV; and
a second optical anisotropy film having said y-axis optic axis on said second linear photo reactive polymer layer by steps of coating said second linear photo reactive polymer layer, heating and exposing with said third UV light.

21. The device as claimed in claim 19, wherein said x-axis is parallel to one moving direction of said first rolled-up film and is perpendicular to said y-axis.

22. An exposing procedure for manufacturing a first optical compensation film and a second optical compensation film, comprising steps of:
a) providing a first rolled-up film having a first optical anisotropy film along a y-axis and a second rolled-up film having a second optical anisotropy film along an x-axis;
b) forming a first linear photo reactive polymer layer and a second linear photo reactive polymer layer on said first rolled-up film and said second rolled-up film respectively;
c) providing a UV light source to emit a first UV light, a second UV light, and a third UV light;
d) condensing said first UV light as a parallel beam by a condenser;
e) generating a reflective polarized-light UV and a transmissive polarized-light UV by receiving said parallel beam, reflecting a vertical electric field component and transmitting a horizontal electric field component simultaneously;
f) respectively exposing said first linear photo reactive polymer layer and said second linear photo reactive polymer layer with said transmissive polarized-light UV and said reflective polarized-light UV for forming a horizontal condensing electric field orientation layer along said x-axis and a vertical condensing electric field orientation layer along said y-axis;
g) respectively coating a first liquid crystal polymer layer on said horizontal condensing electric field orientation layer and a second liquid crystal polymer layer on said vertical condensing electric field orientation layer;
h) heating said horizontal condensing electric field orientation layer and said vertical condensing electric field orientation layer; and
i) respectively exposing said horizontal condensing electric field orientation layer and said vertical condensing electric field orientation layer with said second UV light and said third UV light for forming a third optical anisotropy film having said x-axis optic axis and a fourth optical anisotropy film having said y-axis optic axis.

23. The procedure as claimed in claim 22, wherein said first linear photo reactive polymer layer and said second linear photo reactive polymer layer are formed by coating a linear photo reactive polymer on said first rolled-up film and said second rolled-up film respectively.

24. The procedure as claimed in claim 22, wherein said parallel beam is an electromagnetic wave along a z-axis and has said horizontal electric field component along said x-axis and said vertical electric field component along said y-axis, both vibrating on an x-y plane.

25. The procedure as claimed in claim 22, wherein said reflective polarized-light UV and said transmissive polarized-light UV are both generated by a polarized-light generator.

26. The procedure as claimed in claim 22, wherein said x-axis is parallel to the moving directions of said first rolled-up film and said second rolled-up film and is perpendicular to said y-axis.

27. The procedure as claimed in claim 22, wherein said x-axis is perpendicular to the moving directions of said first rolled-up film and said second rolled-up film and is perpendicular to said y-axis.

28. A method for manufacturing an optical compensation film, comprising steps of:
a) generating a reflective polarized-light UV and a transmissive polarized-light UV;
b) exposing a first linear photo reactive polymer layer with said transmissive polarized-light UV for forming a horizontal electric field orientation layer;
c) coating a first liquid crystal polymer layer on said horizontal electric field orientation layer for forming a first optical anisotropy film along an x-axis;
d) exposing a second linear photo reactive polymer layer on said first optical anisotropy film with said reflective polarized-light UV for forming a vertical electric field orientation layer; and
e) coating a second liquid crystal polymer layer on said vertical electric field orientation layer for forming a second optical anisotropy film along a y-axis.

29. The method as claimed in claim 28, wherein said reflective polarized-light UV and said transmissive polarized-light UV are generated by polarizing a parallel beam being an electromagnetic wave along a z-axis and having an electric field with multiple vibrating directions.

30. The method as claimed in claim 29, wherein said parallel beam is a first UV light with a wave length of 190 nm to 400 nm.

31. The method as claimed in claim 28, wherein said first linear photo reactive polymer layer is formed by coating a first linear photo reactive polymer on a substrate.

32. The method as claimed in claim 28, wherein said step a) is achieved by a polarized-light generator.

33. The method as claimed in claim 28, wherein said reflective polarized-light UV and said transmissive polarized-light UV are formed by reflecting and transmitting a vertical component and a horizontal component of said electric field with multiple vibrating directions respectively.

34. The method as claimed in claim 28, wherein said horizontal electric field orientation layer and said vertical electric field orientation layer are a horizontal condensing electric field orientation layer along said x-axis and a vertical condensing electric field orientation layer along said y-axis respectively.

35. The method as claimed in claim 28, wherein said step c) and step e) both further include steps of heating and exposing with a second UV light and a third UV light respectively.

36. A method for manufacturing an optical compensating film, comprising steps of:
a) generating a reflective polarized-light UV and a transmissive polarized-light UV by receiving a parallel beam;
b) polarizing a first linear photo reactive polymer layer and a second linear photo reactive polymer layer with said transmissive polarized-light UV and said reflective polarized-light UV for forming a horizontal electric field orientation layer and a vertical electric field orientation layer respectively; and
c) coating a first liquid crystal polymer layer on said first linear photo reactive polymer layer and a second liquid crystal polymer layer on said second linear photo reactive polymer layer for forming a first optical anisotropy liquid crystal polymer film along an x-axis and a second optical anisotropy liquid crystal polymer film along a y-axis respectively.

37. The method as claimed in claim 36, wherein said parallel beam is an electromagnetic wave along a z-axis having an electric field with multiple vibrating directions

38. A method for manufacturing an optical compensating film, comprising steps of:
a) generating a reflective polarized-light UV and a transmissive polarized-light UV by receiving a parallel beam;
b) polarizing a first linear photo reactive polymer layer and a second linear photo reactive polymer layer with said transmissive polarized-light UV and said reflective polarized-light UV for forming a horizontal electric field orientation layer and a vertical electric field orientation layer respectively; and
c) coating a first liquid crystal polymer layer on said first linear photo reactive polymer layer and a second liquid crystal polymer layer on said second linear photo reactive polymer layer for forming a first optical anisotropy liquid crystal polymer film along an x-axis and a second optical anisotropy liquid crystal polymer film along a y-axis respectively.

39. The method as claimed in claim 38, wherein said parallel beam is an electromagnetic wave along a specific direction having an electric field with multiple vibrating directions.

40. The method as claimed in claim 39, wherein said specific direction is perpendicular to said x-axis and said y-axis.
